(19) United States
(12) Patent Application Publication
(10) Pub. No.: US 2009/0000844 A1
(43) Pub. Date: Jan. 1, 2009

(54) Fuel module with quick disconnect cover for easy filter replacement

(76) Inventors: Jesus Castillo, Juarez (MX); Arturo Gutierrez, Juarez (MX); Oscar Milan, Juarez (MX); Michael Joseph McHale, El Paso, TX (US)

Correspondence Address: DELPHI TECHNOLOGIES, INC., M/C 480-410-202, PO BOX 5052, TROY, MI, 48007, US

(21) Appl. No.: 11/823,136

(22) Filed: Jun. 27, 2007

(51) Int. Cl. B60K 15/00; F16B 1/00

(52) U.S. Cl. 180/69.4; 403/322.1

(57) ABSTRACT

A fuel module mountable on the fuel tank of a vehicle has a bottom cover extending below the fuel tank. The bottom cover can be quickly removed from the module to allow easy access to the fuel filter in the module.

### FIELD OF THE INVENTION

The present invention relates generally to fuel modules, and more particularly to fuel modules for motor vehicles.

### BACKGROUND OF THE INVENTION

Fuel modules have been provided in which much of a vehicle's fuel system is enclosed in a single housing. Thus, a fuel module may include a fuel pump, a fuel strainer, a pressure regulator, and a fuel filter, and typically is mounted on or in the fuel tank of the vehicle.

As recognized herein, it is sometimes necessary to replace the filter in the module, but this requires removing the entire module from the fuel tank and disassembling it. As further recognized herein, it would be desirable to provide a means to quickly and easily access the filter for replacement without having to remove the entire module from the tank.

### SUMMARY OF THE INVENTION

A fuel module for a vehicle has a housing with an open bottom end, a fuel pump supported by the housing, and a fuel filter in the housing and having a lower end juxtaposed with the open bottom end of the housing. The fuel filter is sized to pass through the open bottom end. A bottom cover is releasably engaged with the housing by a quick disconnect mechanism to selectively cover the open bottom end. With this structure, the bottom cover is removable by hand from the housing by means of the quick disconnect mechanism. If desired, a fuel pressure regulator can be in the housing in communication with the fuel pump.

In some implementations the quick disconnect mechanism may include one more hollow brackets on the cover or the housing and one or more protrusions on the other of the housing or the cover and snappingly engageable with the bracket. In particular non-limiting implementations the quick disconnect mechanism includes first and second brackets on the cover and first and second protrusions on the housing.

In alternate implementations the quick disconnect mechanism includes a threaded part on the cover engaging a threaded part on the housing. In still other implementations the quick disconnect mechanism includes a bayonet channel on the cover or housing and a detent on the other of the housing or cover slidably engaging the bayonet channel. In yet other implementations the quick disconnect mechanism includes a cam-lock mechanism.

In another aspect, a fuel module for a vehicle includes a housing disposable in a fuel tank of the vehicle for supporting a fuel pump in the tank and a fuel filter in the housing and having a lower end juxtaposed with an open bottom end of the housing. The fuel filter is sized to pass through the open bottom end. A bottom cover is engageable with and removable from the housing by means of a quick disconnect mechanism to provide access to the fuel filter without removing the module from the tank.

In still another aspect, in a fuel module having a housing configured for placement in a fuel tank to support a fuel pump and a fuel filter, with the housing being formed with an access through which the fuel filter can be replaced, a cover is configured for blocking the access. Quick disconnect means are provided for releasably holding the cover onto the housing.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a perspective view of the fuel module with bottom cover engaged with the housing, with portions of the fuel tank cut away for clarity and with the fuel pump shown in phantom;

FIG. 2 is an exploded perspective view of the fuel module with bottom cover disengaged with the housing and with the fuel filter shown part way out of the housing, with portions of the fuel tank cut away for clarity and with the fuel pump shown in phantom;

FIG. 3 is a schematic side view of the fuel module showing the internal components and fuel flow;

FIG. 4 is a perspective view of an alternate embodiment in which the quick disconnect mechanism is established by threads; and

FIG. 5 is a perspective view of an alternate embodiment in which the quick disconnect mechanism is established by a bayonet-style coupling between the cover and housing.

### DETAILED DESCRIPTION OF THE PREFERRED EMBODIMENT

The present invention is intended for application in automotive vehicle systems and will be described in that context. It is to be understood, however, that the present invention could also be successfully applied in many other applications including non-vehicle applications.

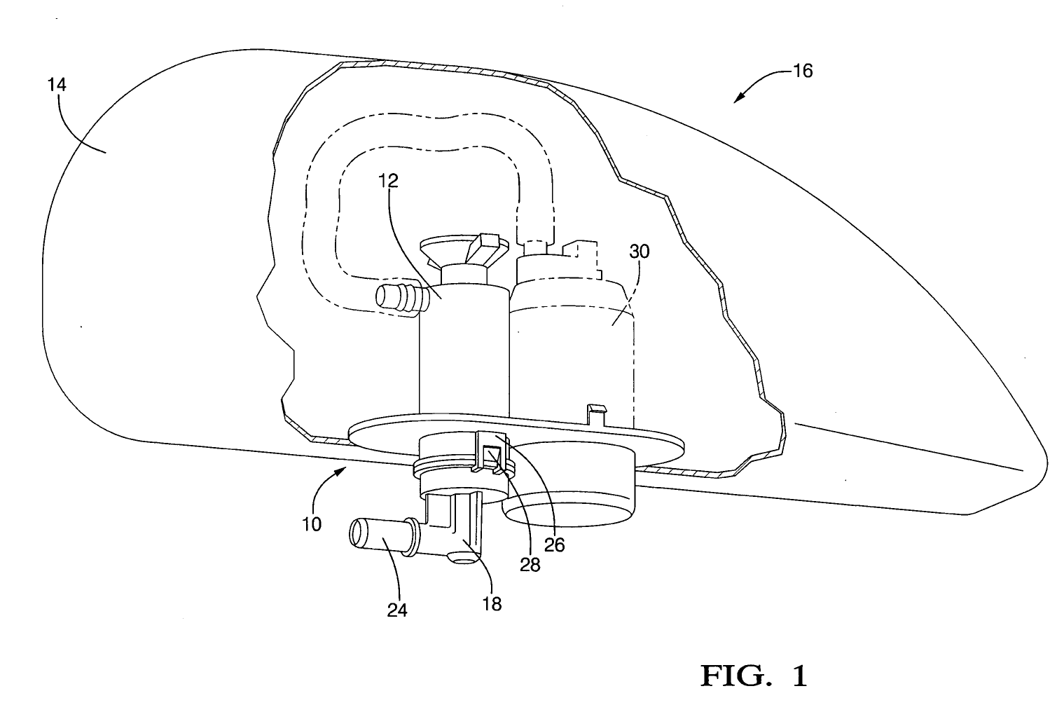

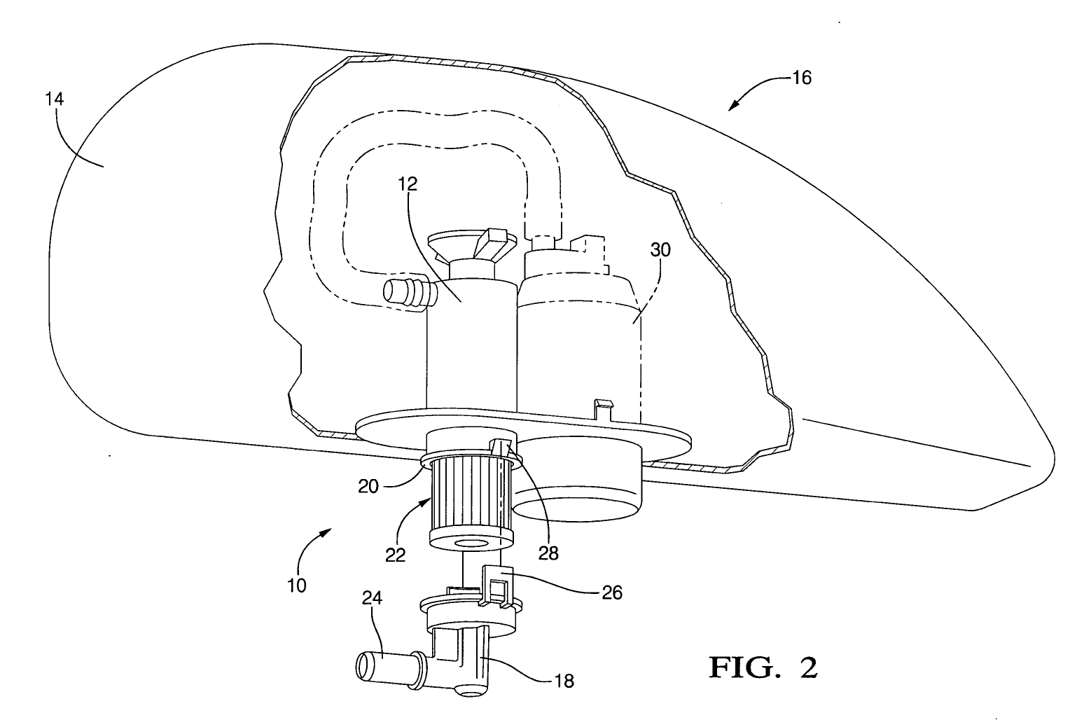

Referring initially to FIGS. 1 and 2, a fuel module is shown, generally designated 10, that includes a fuel module housing 12 disposed mainly within a fuel tank 14 of a vehicle 16, and more specifically in the non-limiting embodiment shown the housing 12 rests on the bottom of the tank 14. A bottom cover 18 is releasably engaged with the housing 12 at the bottom of the tank 14 and outside the tank to cover an open bottom 20 (FIG. 2) of the housing, such that a fuel filter 22 may be advanced into or removed from the housing 12 through the open bottom 20. The cover 18 may be formed with a fuel supply tube 24 as shown to which a fuel line can be connected to convey fuel to the engine.

Both the housing 12 and cover 18 may be respective unitary pieces of material such as plastic or metal.

In the non-limiting embodiment shown in FIGS. 1 and 2, the cover 18 is easily and quickly engageable with and disengageable from the housing 18 by hand by means of the quick disconnect mechanism that includes first and second brackets 26 on opposite upper portions of the cover 18 from each other and first and second protrusions 28 on opposite lower portions of the housing from each other. In some implementations the brackets can be on the housing and the protrusions on the cover. In any case, to engage the cover 18 with the housing in the embodiment shown, the cover is advanced upwardly past the housing with the brackets 26 riding against the protrusions 28, causing the brackets to deform slightly outwardly. When the protrusions 28 are juxtaposed with the openings in the brackets 26, the brackets snap back against the lower part of the housing 12 as shown in FIG. 1 to hold the cover 18 onto the housing 12 at the bottom of the fuel tank, closing the open bottom 20 of the housing 12. In some implementations the brackets 26 may be deformed outwardly by hand to fit them over the protrusions 28. The protrusions 28 are formed complementarily to the openings of the brackets 26 as shown.

To remove the cover 18 from the housing 12, a person need only deform the brackets 26 outwardly either by pulling them apart gently by hand or simply by pulling the cover 18 down away from the housing 12, causing the protrusions 28 to clear the openings of the brackets 26. With the cover 18 disengaged from the housing 12, the fuel filter 22 may be removed from the housing 12 through the open bottom end 20 and replaced with another filter. A seal such as an o-ring or gasket may be provided between the cover 18 and housing 12.

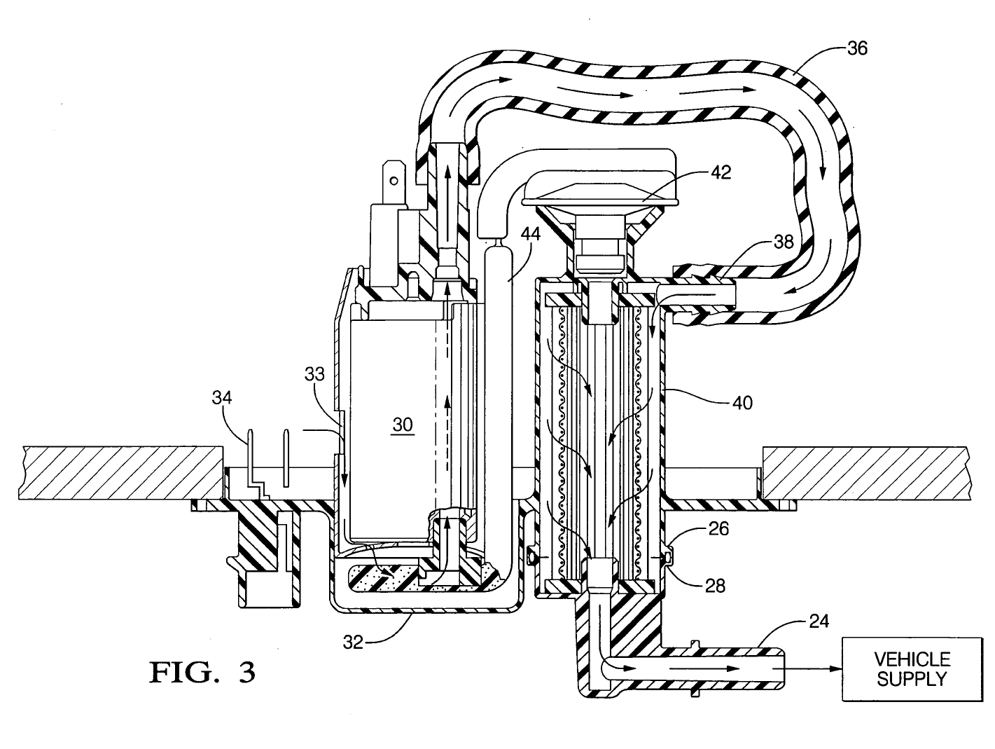

FIG. 3 shows additional details of the non-limiting fuel module shown in FIGS. 1 and 2. As shown, a fuel pump 30 can be supported inside the fuel tank in a pump receptacle 32 of the housing 12. Arrows in FIG. 3 show that the fuel path starts by entering an intake 33 of the fuel pump from the tank near a pump electrical connector 34, also supported on the housing 12 as shown. The fuel is pumped through a delivery tube 36 to the intake 38 of a filter portion 40 of the housing 12 which closely surrounds the fuel filter 22. Some of the fuel passes down through the fuel filter 22 and out of the fuel supply tube 24 to the engine, while some of the fuel is recirculated up through a pressure regulator 42, which regulates fuel pressure. From the pressure regulator 42, the fuel can pass through a strainer 44 and back into the pump intake 33.

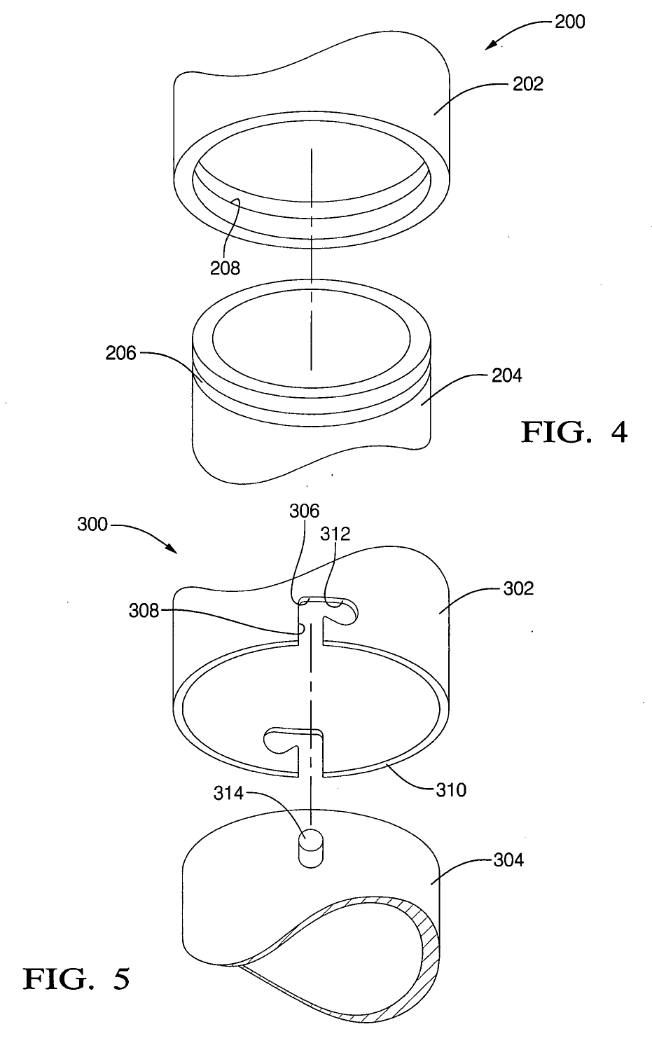

Other connection mechanisms between the cover and fuel module housing may be used. For example, FIG. 4 shows that a fuel module 200 may include a module housing 202 and a cover 204 that in all essential respects are identical to the cover 18 and housing 12 shown in FIGS. 1-3, except that a threaded mechanism is used to removably connect the cover 204 to the module housing 202. Specifically, an upper portion 206 of the cover 204 may be externally threaded as shown for engaging an internally threaded lower portion 208 of the housing 202. The male/female relationship can be reversed between the cover and housing if desired.

Or, as shown in FIG. 5 a fuel module 300 may include a module housing 302 and a cover 304 that in all essential respects are identical to the cover 18 and housing 12 shown in FIGS. 1-3, except that a bayonet connection mechanism is used to removably connect the cover 304 to the module housing 302. Specifically, a generally L-shaped bayonet channel 306 with a vertical part 308 extending up from the open bottom end 310 and terminating in a generally horizontal part 312 may be formed on the housing 302, while a detent 314 may project outwardly from the upper part of the cover 304. To engage the cover 304 with the housing 302, the detent 314 is slid up into the vertical part 308 of the bayonet channel 306 until it reaches the horizontal part 312, at which time the cover 304 is rotated to slide the detent 314 to the end of the horizontal part 312. The process is reversed to remove the cover 304 from the housing 302. The detent may be provided on the housing and the bayonet channel on the cover if desired.

A cam lock-style mechanism may also be used. Non-limiting examples of such mechanisms are given in electrical contexts in the following U.S. patents owned by the present assignee and incorporated herein by reference: U.S. Pat. Nos. 6,896,531, 6,846,191, 6,761,568, 6,422,881, and 6,193,528.

While the particular FUEL MODULE WITH QUICK DISCONNECT COVER FOR EASY FILTER REPLACEMENT is herein shown and described in detail, it is to be understood that the subject matter which is encompassed by the present invention is limited only by the claims. For example, in addition to the above connection mechanisms, other quick connect/quick disconnect type of mechanisms may be used.

What is claimed is:

1. A fuel module for a vehicle, comprising:
a housing with an open bottom end;
a fuel pump supported by the housing;
a fuel filter in the housing and having a lower end juxtaposed with the open bottom end of the housing, the fuel filter being sized to pass through the open bottom end; and
a bottom cover releasably engaged with the housing by a quick disconnect mechanism to selectively cover the open bottom end, the bottom cover being removable by hand from the housing by means of the quick disconnect mechanism.

2. The module of claim 1, wherein the quick disconnect mechanism includes:
at least one hollow bracket on the cover or the housing; and
at least one protrusion on the other of the housing or the cover and snappingly engageable with the bracket.

3. The module of claim 2, wherein the quick disconnect mechanism includes first and second brackets on the cover and first and second protrusions on the housing.

4. The module of claim 1, further comprising a fuel pressure regulator in communication with the fuel pump and mounted in the housing.

5. The module of claim 1, wherein the quick disconnect mechanism includes a threaded part on the cover engaging a threaded part on the housing.

6. The module of claim 1, wherein the quick disconnect mechanism includes a bayonet channel on the cover or housing and a detent on the other of the housing or cover slidably engaging the bayonet channel.

7. The module of claim 1, wherein the quick disconnect mechanism includes a cam-lock mechanism.

8. A fuel module for a vehicle, comprising:
a housing disposable in a fuel tank of the vehicle for supporting a fuel pump in the tank;
a fuel filter in the housing and having a lower end juxtaposed with an open bottom end of the housing, the fuel filter being sized to pass through the open bottom end; and
a bottom cover, the cover being engageable with and removable from the housing by means of a quick disconnect mechanism to provide access to the fuel filter without removing the module from the tank.

9. The module of claim 8, wherein the quick disconnect mechanism includes:
at least one hollow bracket on the cover or the housing; and
at least one protrusion on the other of the housing or the cover and snappingly engageable with the bracket.

10. The module of claim 9, wherein the quick disconnect mechanism includes first and second brackets on the cover and first and second protrusions on the housing.

11. The module of claim 8, further comprising a fuel pressure regulator in communication with the fuel pump and mounted in the housing.

12. The module of claim 8, wherein the quick disconnect mechanism includes a threaded part on the cover engaging a threaded part on the housing.

13. The module of claim 8, wherein the quick disconnect mechanism includes a bayonet channel on the cover or housing and a detent on the other of the housing or cover slidably engaging the bayonet channel.

14. The module of claim 8, wherein the quick disconnect mechanism includes a cam-lock mechanism.

15. In a fuel module having a housing configured for placement in a fuel tank to support a fuel pump and a fuel filter, with the housing being formed with an access through which the fuel filter can be replaced:
a cover configured for blocking the access; and
quick disconnect means for releasably holding the cover onto the housing.

16. The module of claim 15, wherein the quick disconnect means includes:
at least one hollow bracket on the cover or the housing; and
at least one protrusion on the other of the housing or the cover and snappingly engageable with the bracket.

17. The module of claim 16, wherein the quick disconnect means includes first and second brackets on the cover and first and second protrusions on the housing.

18. The module of claim 15, further comprising a fuel pressure regulator in communication with the fuel pump and mounted in the housing.

19. The module of claim 15, wherein the quick disconnect means includes a threaded part on the cover engaging a threaded part on the housing.

20. The module of claim 15, wherein the quick disconnect means includes a bayonet channel on the cover or housing and a detent on the other of the housing or cover slidably engaging the bayonet channel, or a cam-lock mechanism.
